(19) United States
(12) Patent Application Publication
(10) Pub. No.: US 2006/0220773 A1
(43) Pub. Date: Oct. 5, 2006

(54) Spiral transformers and associated methods of operation

(76) Inventors: Jun Su, San Jose, CA (US); Valluri Rao, Saratoga, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/096,196

(22) Filed: Mar. 31, 2005

(51) Int. Cl. H01F 5/00

(52) U.S. Cl. 336/200

(57) ABSTRACT

In an embodiment, a transformer includes a first inductor electromagnetically coupled with a second inductor. The first and second inductors each have a spiral geometry in first and second areas, respectively, that are separated from each other on a surface of a substrate. In a method of operation, a second signal is generated in a second inductor through electromagnetic coupling with a first signal received by a first inductor.

### TECHNICAL FIELD

This application relates generally to transformers and, more particularly, to spiral transformers.

### BACKGROUND

A transformer is a pair of inductors that are arranged such that electromagnetic energy is coupled from one inductor to the other. Transformers are used in a wide variety of electronic circuits to filter and amplify signals, among other uses. Transformers are used in both passive and active electronic circuits. The performance of a transformer depends in part on the shape and arrangement of the inductors. There is a need for transformers with characteristics that enhance the performance of electronic circuits.

### BRIEF DESCRIPTION OF THE DRAWINGS

FIG. 1 illustrates a transformer according to various embodiments;

FIG. 2 illustrates a cross-section of an integrated circuit device according to various embodiments;

FIG. 3 illustrates a transformer according to various embodiments;

FIG. 4 illustrates a transformer according to various embodiments;

FIG. 5 illustrates a radio frequency filter according to various embodiments;

FIG. 6 illustrates a coupling coefficient κ versus an edge-to-edge gap g for a transformer according to various embodiments;

FIG. 7 illustrates a plot of insertion loss and return loss for a radio frequency bandpass filter including a transformer according to various embodiments;

FIG. 8 illustrates a block diagram of a wireless computing platform according to various embodiments; and

FIG. 9 illustrates a flow diagram of several methods according to various embodiments.

### DETAILED DESCRIPTION

In the following detailed description of various embodiments, reference is made to the accompanying drawings that form a part hereof, and in which are shown by way of illustration, and not of limitation, specific embodiments in which the subject matter may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that compositional, structural, and logical substitutions and changes may be made without departing from the scope of this disclosure. The following detailed description, therefore, is not to be taken in a limiting sense. Examples and embodiments merely typify possible variations. Individual components and functions are optional unless explicitly required, and the sequence of operations may vary. Portions and features of some embodiments may be included in or substituted for those of others. The following description is, therefore, not to be taken in a limiting sense.

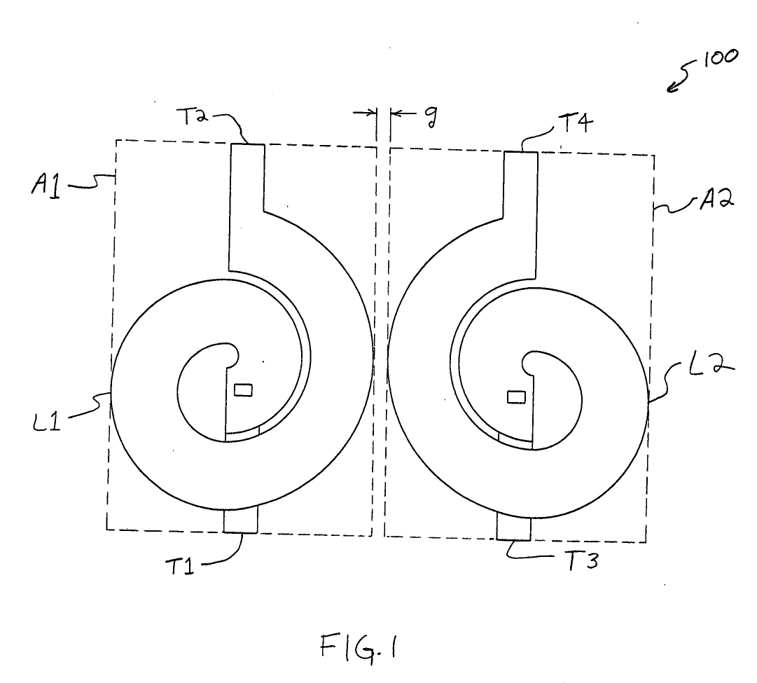

FIG. 1 illustrates a transformer 100 according to various embodiments. The transformer 100 includes a first inductor L1 having a spiral geometry in a first area A1 on a planar surface and a second inductor L2 having a spiral geometry in a second area A2 on the planar surface. The second area A2 is separated from the first area A1 by an edge-to-edge gap g. The first inductor L1 is not intertwined or interleaved or interwoven or stacked with the second inductor L2. The spiral geometry of the first inductor L1 winds in either a clockwise or counter-clockwise direction and the spiral geometry of the second inductor L2 winds in either a clockwise or counter-clockwise direction. The second inductor L2 winds in the same or opposite direction to that of the first inductor L1 according to various embodiments. Each of the first inductor L1 and the second inductor L2 is coupled to terminals. A first terminal T1 is coupled to a center of the first inductor L1 and a second terminal T2 is coupled to a terminal end of the first inductor L1. A third terminal T3 is coupled to a center of the second inductor L2, and a fourth terminal T4 is coupled to a terminal end of the second inductor L2.

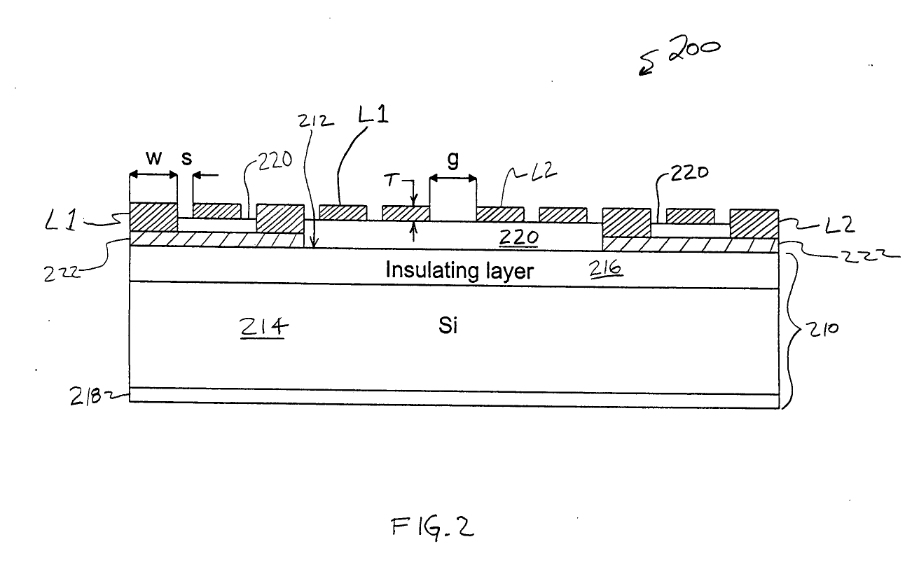

FIG. 2 illustrates a cross-section of an integrated circuit device 200 according to various embodiments. The transformer 100 shown in FIG. 1 may be fabricated as part of the integrated circuit device 200 shown in cross-section in FIG. 2 according to an embodiment. The device 200 is fabricated on an integrated circuit substrate 210 having a planar surface 212. The first inductor L1 is formed in the first area A1 of the planar surface 212 of the substrate 210, and the second inductor L2 is formed in the second area A2 of the planar surface 212 of the substrate 210. The first area A1 and the second area A2 are not visible in the cross-section shown in FIG. 2. The second area A2 is separated from the first area A1 by the edge-to-edge gap g. Each of the first inductor L1 and the second inductor L2 is an air core metal inductor according to an embodiment. The first inductor L1 and the second inductor L2 are each fabricated of gold, copper, or aluminum in alternate embodiments. The first inductor L1 and the second inductor L2 are each formed by one or more of sputter deposition, evaporation, electroplating, inkjet printing, lamination, or lamination with etching of a metal.

The substrate 210 includes an intrinsic silicon substrate 214 and an insulating layer 216 on a top planar surface of the silicon substrate 214. A metallization 218 is formed on a bottom planar surface of the silicon substrate 214. The insulating layer 216 may be a layer of silicon dioxide according to an embodiment. An inter-metal dielectric 220 is formed on the insulating layer 216 and on a layer of underpassing metal 222 that is formed on some of the insulating layer 216.

In various embodiments, each of the first inductor L1 and the second inductor L2 is formed from electroplated gold that is in the range of 2-15 microns thick. In one embodiment, the electroplated gold is approximately six microns thick. A first portion of the first inductor L1 is located on the inter-metal dielectric 220, and a second portion of the first inductor L1 is located on a first portion of the underpassing metal 222. A first portion of the second inductor L2 is located on the inter-metal dielectric 220, and a second portion of the second inductor L2 is located on a second portion of underpassing metal 222. The underpassing metal 222 separates the first inductor L1 and the second inductor L2 from the insulating layer 216. In alternate embodiments, the substrate 210 is made of Galium Arsenide (GaAs), glass, laminate, Bismaleimide Triazine (BT) laminate, ceramic, intrinsic silicon, high-resistivity silicon, or a printed circuit (PC) board. In addition heavily doped silicon such as a heavily doped CMOS substrate could also be used, if substrate losses and degradation of the Inductor Q factors are tolerable for the circuit application. In the remainder of this description, the intrinsic silicon substrate is used by way of example. Any of the above substrates could be substituted in place of the intrinsic silicon substrate.

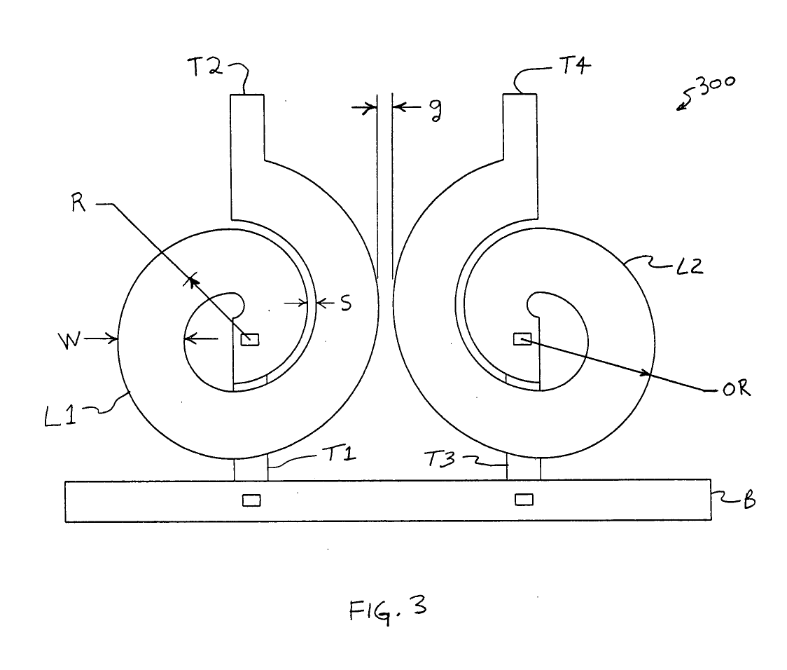

FIG. 3 illustrates a transformer 300 according to various embodiments. The transformer 300 is shown in FIG. 3 according to an embodiment including dimensions expressing the geometry of the transformer 300. The transformer 300 is the same as the transformer 100 shown in FIG. 1, and it further includes a conductive bar B connected to the first terminal T1 and the third terminal T3. The conductive bar B is coupled to a reference voltage during operation. Some of the dimensions shown in FIG. 3 are also shown in FIG. 2. The first inductor L1 and the second inductor L2 are arranged side by side separated by the edge-to-edge gap g. Each of the first inductor L1 and the second inductor L2 has a width W and a trace separation S separating the winding of the inductor from itself. Strength of mutual inductive coupling between the first inductor L1 and the second inductor L2 is a function of W, S, g, and an outside radius OR of each of the first inductor L1 and the second inductor L2 that determines a mutual coupling area. Each of the first inductor L1 and the second inductor L2 also has a thickness T perpendicular to the planar surface 212, a number of turns N (not shown), and a centerline traced by a radius R. The outside radius OR of each inductor is based on the width W, trace separation S, and the number of turns N.

According to one embodiment, the radius R of one or both of the inductors L1, L2 increases as the radius R is rotated from an initial position through a first angle, the radius R increasing based on its angle of rotation that increases as the radius R rotates. The radius R increases to a limiting radius at the first angle, then the radius R remains constant as it further rotates through the geometry of the inductor L1, L2.

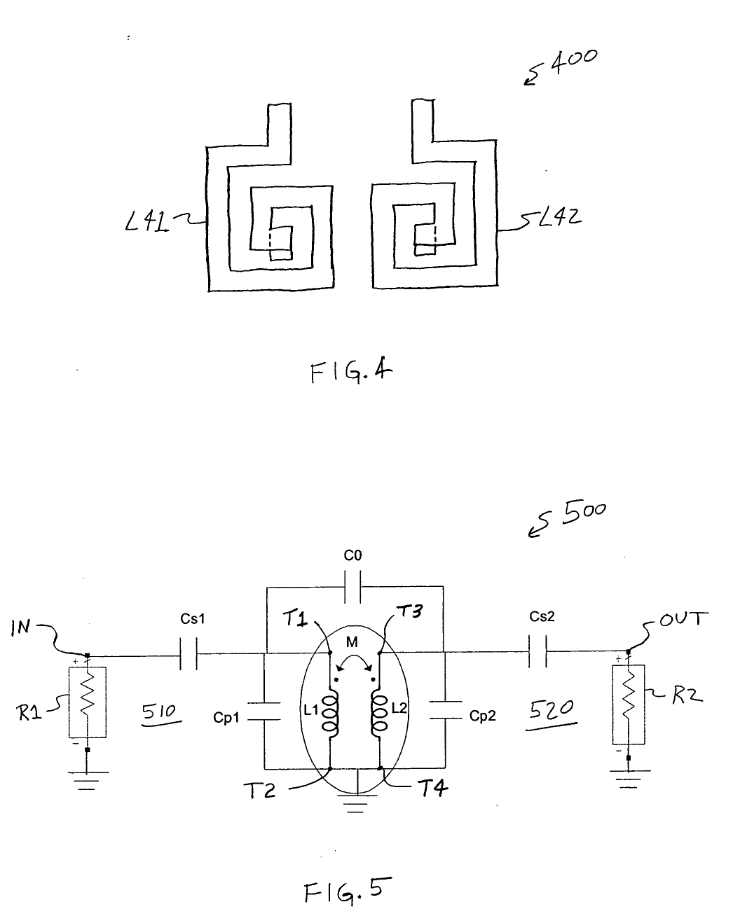

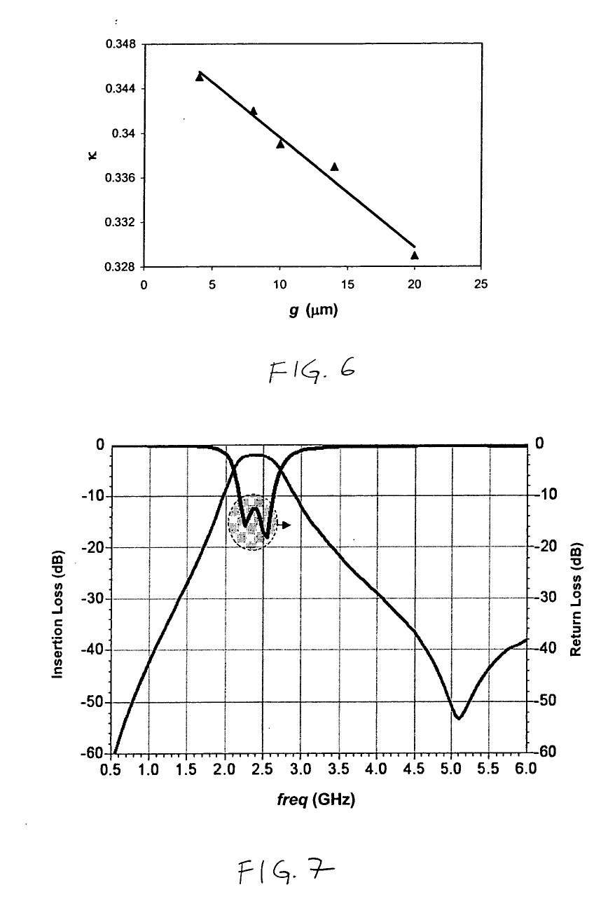

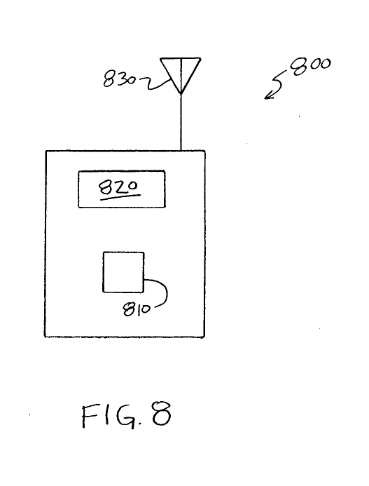

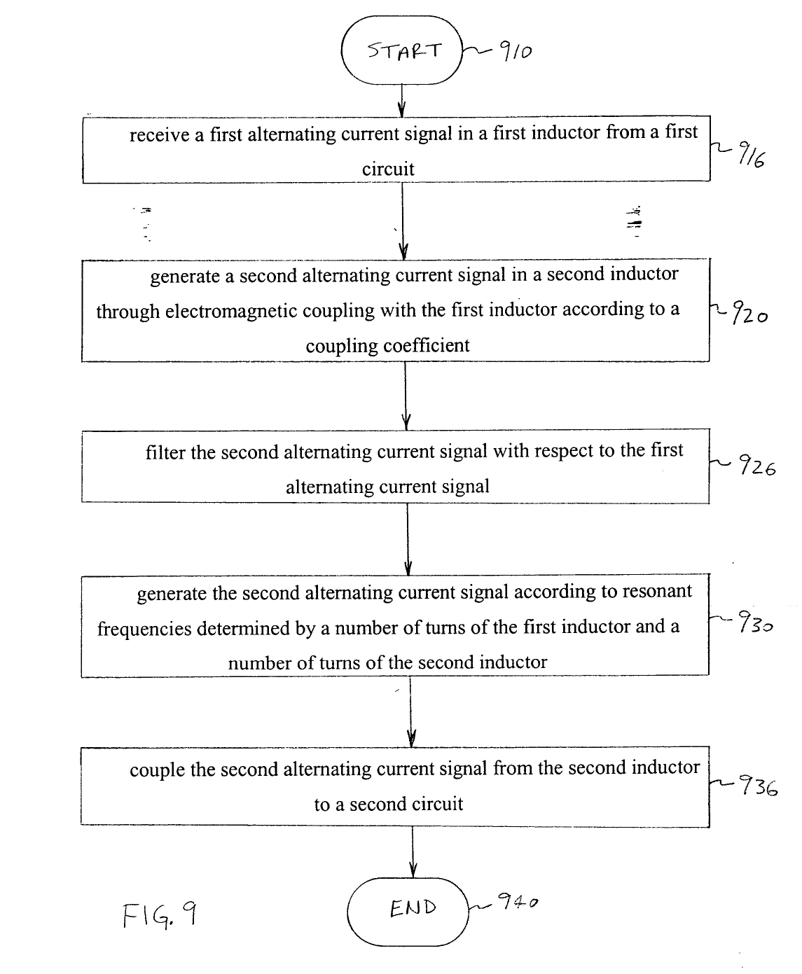

The spiral geometry of each of the first inductor L1 and the second inductor L2 shown in FIG. 1 may be an Archimedean spiral, an equiangular spiral, a rectangular spiral, a circular spiral, or any other type of spiral. For example, a transformer 400 is shown in FIG. 4 according to an embodiment having inductors L41 and L42 each with a rectangular spiral geometry, as will now be discussed.

FIG. 4 illustrates a transformer 400 according to various embodiments. In an embodiment, the rectangular spiral geometry of a first inductor L41 is a symmetrical or mirror image of the second inductor L42. The transformer 400 is similar to the transformer 100 in other respects. In alternate embodiments, the spiral geometry of the first inductor L1 is not the same as the spiral geometry of the second inductor L2.

The transformer 100 is operated in the following manner according to an embodiment. A first signal is received in the first inductor L1, and a second signal is generated in the second inductor L2 from electromagnetic coupling with the first inductor L1. The first signal is coupled from the first inductor L1 to the second inductor L2 according to a coupling coefficient κ dependent on the edge-to-edge gap g and the outside radius OR of the second inductor L2. The first inductor L1 and the second inductor L2 are mutually coupled with a mutual inductance M where M=κ*sqrt(L1*L2) and L1 and L2 are the inductances of the first inductor L1 and the second inductor L2, respectively. In one embodiment, the second signal is filtered with respect to the first signal by a circuit comprising the first inductor L1 and the second inductor L2. In another embodiment, the second signal is generated according to resonant frequencies determined by the number of turns N1 of the first inductor L1 and the number of turns N2 of the second inductor L2 in resonators including capacitive elements. According to an embodiment, the first signal is coupled to the first inductor L1 from a first circuit, and the second signal is coupled from the second inductor L2 to a second circuit.

The first inductor L1 and the second inductor L2 can provide magnetic coupling between resonators according to an embodiment.

FIG. 5 illustrates a radio frequency (RF) filter 500 according to various embodiments. The RF filter 500 is shown in FIG. 5 according to an embodiment in which Cs and Cp are series and shunt capacitors and C0 is a coupling capacitor.

A first circuit 510 of the filter 500 is coupled between the first terminal T1 and the second terminal T2 of the first inductor L1. A second circuit 520 of the filter 500 is coupled between the third terminal T3 and the fourth terminal T4 of the second inductor L2. The first circuit 510 includes a first series capacitor Cs1 coupled between a signal input IN and the first terminal T1 of the first inductor L1 and a first shunt capacitor Cp1 coupled in parallel with the first inductor L1.

The second circuit 520 includes a second series capacitor Cs2 coupled between the third terminal T3 of the second inductor L2 and a signal output OUT and a second shunt capacitor Cp2 coupled in parallel with the second inductor L2. A coupling capacitor C0 is coupled between the first terminal T1 of the first inductor L1 and the third terminal T3 of the second inductor L2. The second terminal T2 of the first inductor L1 and the fourth terminal T4 of the second inductor L2 are coupled to a reference voltage such as a ground voltage according to an embodiment. A first load R1 is coupled between the signal input IN and the reference voltage, and a second load R2 is coupled between the signal output OUT and the reference voltage.

In a lumped-element model of the filter 500, the coupling between the first inductor L1 and the second inductor L2 is expressed in a form of an inductor transformer whose operation is to couple alternative current from the first inductor L1 to the second inductor L2 without a significant loss of power and to transform the impedance levels between the inductors L1 and L2.

FIG. 6 illustrates a coupling coefficient κ versus an edge-to-edge gap g for a transformer according to various embodiments. The coupling coefficient κ versus the edge-to-edge gap g for the transformer 100 when other parameters are preset is shown in FIG. 6 according to an embodiment. Advantages of the embodiments described herein include the adjustable coupling coefficient κ, which can be adjusted by changing the edge-to-edge gap g, a merit to RF filter designs. The side-by-side topology of the coupled pair of inductors L1 and L2 results in flexibility and simplicity for integration of other passive components and in I/O arrangements.

FIG. 7 illustrates a plot of insertion loss and return loss for a radio frequency bandpass filter (not shown) including a transformer, such as the transformer 100, according to various embodiments. According to this embodiment, the RF bandpass filter is fabricated with silicon technology and operates at 2.45 GHz.

FIG. 8 illustrates a block diagram of a wireless computing platform 800 according to various embodiments. According to embodiments, the transformer 100 is part of a module in a wireless computing platform such as the wireless computing platform 800. The wireless computing platform 800 may interact with one or more networks such as a WAN (Wireless Area Network), a WLAN (Wireless Local Area Network), and a WPAN (Wireless Personal Area Network). The wireless computing platform 800 may be hand-held or larger. The wireless computing platform 800 includes a module 810, a display 820, and an antenna 830. The antenna 830 may comprise a monopole, a dipole, a unidirectional antenna, an omnidirectional antenna, or a patch antenna, among others. The module 810 includes the transformer 100. A wireless computing platform may be any device capable of conducting wireless communication (e.g., infra-red, radio frequency, etc.) and executing a series of programmed instructions (e.g., a personal digital assistant, a laptop, a cellular telephone, etc.).

The module 810 may include an active radio frequency integrated circuit or a passive radio frequency integrated circuit, or both according to embodiments. The wireless computing platform 800 may be a radio frequency device. The module 810 may be a filter such as a narrow band filter or a wideband filter, a diplexer (having multiple filters), a low-noise amplifier (LNA), a power amplifier, or a resonator.

FIG. 9 illustrates a flow diagram of several methods according to various embodiments. In 910, the methods start.

In 916, a first alternating current signal is received in a first inductor from a first circuit.

In 920, a second alternating current signal is generated in a second inductor through electromagnetic coupling with the first inductor according to a coupling coefficient.

In 926, the second alternating current signal is filtered with respect to the first alternating current signal.

In 930, the second alternating current signal is generated according to resonant frequencies determined by a number of turns of the first inductor and a number of turns of the second inductor.

In 936, the second alternating current signal is coupled from the second inductor to a second circuit. In 940, the methods end.

It should be noted that the individual activities shown in the flow diagram do not have to be performed in the order illustrated or in any particular order. Moreover, various activities described with respect to the methods identified herein can be executed in serial or parallel fashion. Some activities may be repeated indefinitely, and others may occur only once. Various embodiments may have more or fewer activities than those illustrated.

Embodiments described herein show on-chip high-Q monolithic spiral transformers for RF filter applications, among others. The embodiments offer a mutual inductor coupling coefficient with an adjustable range from 0.03 to 0.4, ideal for the design of RF filters. Furthermore, the side-by-side topology for the coupled pair of inductors results in flexibility and simplicity for integration of other passive components and I/O arrangements. Also, the coupled spiral inductor transformers according to the embodiments result in low insertion loss and compactness for RF filters.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” may be used as the plain-English equivalents of the respective terms “comprising” and “wherein,” respectively. Moreover, the terms “first,” “second,” and “third,” etc. are used merely as labels, and are not intended to impose numerical requirements on their objects.

What is claimed is:

1. A transformer comprising:
a first inductor comprising a spiral geometry in a first area on a planar surface of an integrated circuit substrate; and
a second inductor comprising a spiral geometry in a second area on the planar surface of the substrate, the second area being separated from the first area by a separation distance.

2. The transformer of claim 1 wherein the first inductor is not intertwined or interleaved or interwoven or stacked with the second inductor.

3. The transformer of claim 1 wherein:
the spiral geometry of the first inductor comprises an Archimedean spiral or an equiangular spiral or a rectangular spiral or a circular spiral; and
the spiral geometry of the second inductor comprises an Archimedean spiral or an equiangular spiral or a rectangular spiral or a circular spiral.

4. The transformer of claim 1 wherein:
the spiral geometry of the first inductor winds in a clockwise or a counter-clockwise direction; and
the spiral geometry of the second inductor winds in the same or opposite direction to that of the first inductor.

5. The transformer of claim 1 wherein the spiral geometry of the first inductor is not the same as the spiral geometry of the second inductor.

6. The transformer of claim 1 wherein:
the spiral geometry of the first inductor is defined by dimensions including a thickness perpendicular to the planar surface of the substrate, a width, a number of turns, and an outside radius based on the width and the number of turns; and
the spiral geometry of the second inductor is defined by dimensions including a thickness perpendicular to the planar surface of the substrate, a width, a number of turns, and an outside radius based on the width and the number of turns.

7. The transformer of claim 1 wherein the spiral geometry of the first inductor is defined by dimensions including a thickness perpendicular to the planar surface of the substrate, a width, and a centerline traced by a radius that increases as the radius is rotated from an initial position through a first angle, the radius increasing based on an angle of rotation of the radius that increases as the radius rotates, the radius increasing to a limiting radius at the first angle, then the radius remaining constant as it further rotates through the spiral geometry.

8. The transformer of claim 1, further comprising:
a first terminal coupled to a center of the first inductor;
a second terminal coupled to a terminal end of the first inductor, the first terminal and the second terminal being coupled to a first circuit;
a third terminal coupled to a center of the second inductor; and
a fourth terminal coupled to a terminal end of the second inductor, the third terminal and the fourth terminal being coupled to a second circuit.

9. The transformer of claim 1 wherein:
the first inductor comprises metal; and
the second inductor comprises metal.

10. An integrated circuit device comprising:
an integrated circuit substrate comprising a planar surface;
a first inductor comprising a spiral geometry in a first area of the planar surface of the substrate; and
a second inductor comprising a spiral geometry in a second area of the planar surface of the substrate, the second area being separated from the first area by a separation distance, the first inductor and the second inductor comprising a transformer.

11. The integrated circuit device of claim 10 wherein the first inductor is not intertwined or interleaved or interwoven or stacked with the second inductor.

12. The integrated circuit device of claim 10 wherein the first inductor and the second inductor each comprise an air core metal inductor.

13. The integrated circuit device of claim 10 wherein the first inductor and the second inductor each comprise gold, copper, or aluminum.

14. The integrated circuit device of claim 10 wherein the first inductor and the second inductor each comprise a metal inductor that is formed by one or more of sputter deposition, evaporation, electroplating, inkjet printing, lamination, or lamination with etching of the metal.

15. The integrated circuit device of claim 10 wherein the substrate comprises a substrate material selected from the group consisting of Galium Arsenide (GaAs), glass, Bismaleimide Triazine, laminate, ceramic, intrinsic silicon, high-resistivity silicon, heavily doped silicon, heavily doped CMOS silicon, and printed circuit board.

16. The integrated circuit device of claim 10 wherein the first inductor and the second inductor on the planar surface of the substrate are elements within one of a filter, a narrow band filter, a wideband filter, a diplexer, a low-noise amplifier, a power amplifier, or a resonator in a radio frequency device.

17. The integrated circuit device of claim 10 wherein:
the substrate comprises:
an intrinsic silicon substrate;
a layer of silicon dioxide on a first planar surface of the silicon substrate;
a metallization on a second planar surface of the silicon substrate; and
an inter-metal dielectric on the layer of silicon dioxide;
the first inductor comprises electroplated gold having a thickness in the range of 2-15 microns, a first portion of the first inductor being located on the inter-metal dielectric, and a second portion of the first inductor being located on a first portion of underpassing metal, the first portion of underpassing metal separating the first inductor from the layer of silicon dioxide; and
the second inductor comprises electroplated gold having a thickness in the range of 2-15 microns, a first portion of the second inductor being located on the inter-metal dielectric, and a second portion of the second inductor being located on a second portion of underpassing metal, the second portion of underpassing metal separating the second inductor from the layer of silicon dioxide.

18. A system comprising:
a first inductor comprising a spiral geometry between a first terminal and a second terminal, the first inductor being located in a first area on a planar surface of an integrated circuit substrate;
a second inductor comprising a spiral geometry between a third terminal and a fourth terminal, the second inductor being located in a second area on the planar surface of the substrate, the second area being separated from the first area by a separation distance;
a first circuit coupled between the first terminal and the second terminal; and
a second circuit coupled between the third terminal and the fourth terminal.

19. The system of claim 18 wherein:
the first inductor comprises metal;
the second inductor comprises metal;
the spiral geometry of the first inductor winds in a counter-clockwise or clockwise direction;
the spiral geometry of the second inductor winds in the same or opposite direction to that of the first inductor; and
the first inductor is not intertwined or interleaved or interwoven or stacked with the second inductor.

20. The system of claim 18 wherein
the first circuit comprises:
a series capacitor coupled between a signal input and the first terminal of the first inductor; and
a shunt capacitor coupled in parallel with the first inductor;
the second circuit comprises:
a series capacitor coupled between the third terminal of the second inductor and a signal output; and
a shunt capacitor coupled in parallel with the second inductor; and
wherein:
the system further comprises a coupling capacitor coupled between the first terminal of the first inductor and the third terminal of the second inductor; and
the second terminal of the first inductor and the fourth terminal of the second inductor are coupled to a reference voltage.

21. The system of claim 18 wherein the system comprises a filter.

22. The system of claim 18 wherein the system is located in a module in a radio frequency device.

23. The system of claim 22 wherein the module comprises an active radio frequency integrated circuit or a passive radio frequency integrated circuit.

24. The system of claim 18 wherein the first inductor, the second inductor, the first circuit, and the second circuit form one of a filter, a narrow band filter, a wideband filter, a diplexer, a low-noise amplifier, a power amplifier, or a resonator.

25. A method comprising:
receiving a first signal in a first inductor, the first inductor comprising a spiral geometry in a first area on a planar surface of an integrated circuit substrate;
generating a second signal in a second inductor from electromagnetic coupling with the first inductor, the second inductor comprising a spiral geometry in a second area on the planar surface of the substrate, the second area being separated from the first area by a separation distance.

26. The method of claim 25 wherein:
receiving a first signal further comprises receiving the first signal comprising an alternating current signal; and
generating a second signal further comprises generating the second signal comprising an alternating current signal.

27. The method of claim 25 wherein:
generating a second signal further comprises coupling the first signal from the first inductor to the second inductor according to a coupling coefficient dependent on the separation distance and an outside radius of the second inductor; and
wherein the first inductor is not intertwined or interleaved or interwoven or stacked with the second inductor.

28. The method of claim 25 wherein generating a second signal further comprises generating the second signal that is filtered with respect to the first signal by the first inductor and the second inductor.

29. The method of claim 25 wherein generating a second signal further comprises generating the second signal according to resonant frequencies determined by a number of turns of the first inductor and a number of turns of the second inductor.

30. The method of claim 25, further comprising:
coupling the first signal to the first inductor from a first circuit; and
coupling the second signal from the second inductor to a second circuit.
